(19) United States
(12) Patent Application Publication
(10) Pub. No.: US 2022/0138459 A1
(43) Pub. Date: May 5, 2022

(54) RECOGNITION SYSTEM OF HUMAN BODY POSTURE, RECOGNITION METHOD OF HUMAN BODY POSTURE, AND NON-TRANSITORY COMPUTER-READABLE STORAGE MEDIUM

(71) Applicant: INSTITUTE FOR INFORMATION INDUSTRY, Taipei (TW)

(72) Inventors: Yu-Ting PENG, Taipei (TW); Yan-Sheng SONG, Taipei (TW); Ting-Huan KUO, Taipei (TW)

(21) Appl. No.: 17/105,663

(22) Filed: Nov. 27, 2020

(30) Foreign Application Priority Data
Nov. 4, 2020 (TW) 109138489

(51) Int. Cl. G06K 9/00; G06T 7/50; G06T 7/60; G06T 7/70; G06K 9/62

(52) U.S. Cl. CPC G06K 9/00375; G06T 7/50; G06T 7/60; G06T 2207/20081; G06K 9/6217; G06T 2207/30196; G06T 7/70

(57) ABSTRACT

A recognition system of human body posture includes a source image device, a storage device, and a processing device. The storage device is configured to store a posture recognition model and the posture recognition model is configured for inputting a skeleton image and outputting a recognition result. The skeleton image includes a skeleton and the skeleton includes a plurality of joints and a plurality of limbs. Each of the limbs corresponds to a limb color, and each of the limb colors is different from each other. The processing device is configured to: generate the skeleton images from the pending recognition images; input the skeleton images into the posture recognition model respectively to output the recognition result which corresponds to the skeleton images inputted; and determine whether abnormal information is sent according to the recognition result.

### CROSS-REFERENCE TO RELATED APPLICATION

This application claims priority to and the benefit of Taiwan Application Serial Number 109138489, filed on Nov. 4, 2020, the entire content of which is incorporated herein by reference as if fully set forth below in its entirety and for all applicable purposes.

### BACKGROUND

### Field of Disclosure

The disclosure generally relates to a recognition system and a recognition method, and more particularly, to a recognition system of human body posture and a recognition system of human body posture.

### Description of Related Art

The recognition method of human body posture is commonly applied in a public place to review states of the people in the field through the human body postures to make sure public safety. For example, when the people on the road, in the traffic environment, or on the public transportation fall down, not only the people get injured and urgent care is necessary, but also chaos occurs due to the falling down. It is dangerous to public safety.

To preserve public safety in the field, cameras can be deployed in public places to monitor the field. However, the current image processing technique for recognizations is influenced by the complexity of the area or location, the camera angle, the variation in light intensity, such that it is difficult to recognize the state of the people who is in the area by processing the image. When the area or location is complicated or there are many people in the area, such that people in the image overlap, the entire image of each person cannot be captured. Because the current image recognization algorithm applies the gray image, not only the left/right and distances of the people but also the image contents cannot be determined. Therefore, the current image processing technique of training the model and recognizing the images has bad efficiency.

### SUMMARY

The disclosure can be more fully understood by reading the following detailed description of the embodiments, with reference made to the accompanying drawings as described below. It should be noted that the features in the drawings are not necessarily to scale. In fact, the dimensions of the features may be arbitrarily increased or decreased for clarity of discussion.

The present disclosure of an embodiment provides a recognition system of human body posture which includes a source image device, a storage device, and a processing device. The resource image device is configured to receive a plurality of pending recognition images. The storage device is configured to store a posture recognition model and the posture recognition model is configured to input a skeleton image and output a recognition result. The skeleton image includes a skeleton and the skeleton includes a plurality of joints and a plurality of limbs. Each of the limbs corresponds to a limb color, and each of the limb colors is different from each other. The processing device is coupled with the source image device and the storage device, and the processing device is configured to: generate the skeleton images from the pending recognition images; input the skeleton images into the posture recognition model respectively to output the recognition result which corresponds to the skeleton images inputted; and determine whether abnormal information is sent according to the recognition result.

One aspect of the present disclosure is to provide a recognition method of human body posture including: receiving a plurality of pending recognition images; generating a plurality of skeleton images from the pending recognition images, wherein the skeleton image comprises a skeleton, the skeleton comprises a plurality of joints and a plurality of limbs, each of the limbs corresponds to a limb color, and each of the limb colors is different from each other; inputting the skeleton images into a posture recognition model respectively to output a recognition result which corresponds to the skeleton images inputted; and determining whether abnormal information is sent according to the recognition result.

One aspect of the present disclosure is to provide a non-transitory computer-readable storage medium including instructions stored thereon, and the instructions are configured to cause a processor to: receive a plurality of pending recognition images; generate a plurality of skeleton images from the pending recognition images, wherein the skeleton image comprises a skeleton, the skeleton includes a plurality of joints and a plurality of limbs, each of the limbs corresponds to a limb color, and each of the limb colors is different from each other; input the skeleton images into a posture recognition model respectively to output a recognition result which corresponds to the skeleton images inputted; and determine whether abnormal information should be sent according to the recognition result.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as described below. It should be noted that the features in the drawings are not necessarily to scale. In fact, the dimensions of the features may be arbitrarily increased or decreased for clarity of discussion.

FIG. 1 is a schematic diagram illustrating a pending recognition image of a video captured in a scene according to some embodiments of the present disclosure.

FIG. 2 is a block diagram of a recognition system of human body posture according to some embodiments of the present disclosure.

FIG. 3A to FIG. 3D show skeleton images stored in a posture recognition model according to some embodiments of the present disclosure.

FIG. 4 is a flow chart illustrating a recognition method of human body posture according to some embodiments of the present disclosure.

FIG. 5A to FIG. 5B shows a schematic diagram of adjusting the skeleton image according to some embodiments of the present disclosure.

### DETAILED DESCRIPTION

The technical terms “first”, “second” and the similar terms are used to describe elements for distinguishing the same or similar elements or operations and are not intended to limit the technical elements and the order of the operations in the present disclosure. Furthermore, the element symbols/alphabets can be used repeatedly in each embodiment of the present disclosure. The same and similar technical terms can be represented by the same or similar symbols/alphabets in each embodiment. The repeated symbols/alphabets are provided for simplicity and clarity and they should not be interpreted to limit the relation of the technical terms among the embodiments.

The surveillance system can provide the videos captured from cameras that are disposed on different scenes (such as the MRT, the train stations, the department stores, and so on). The administrator has to watch the monitor of the surveillance system at all times and check the monitoring screen to determine whether any accident event occurs in the scene. However, there is a risk of determinations. If the administrator missed for a short while or the display is flawed or damaged, such an accidental situation could lead to a bad result according to losing control of the scene.

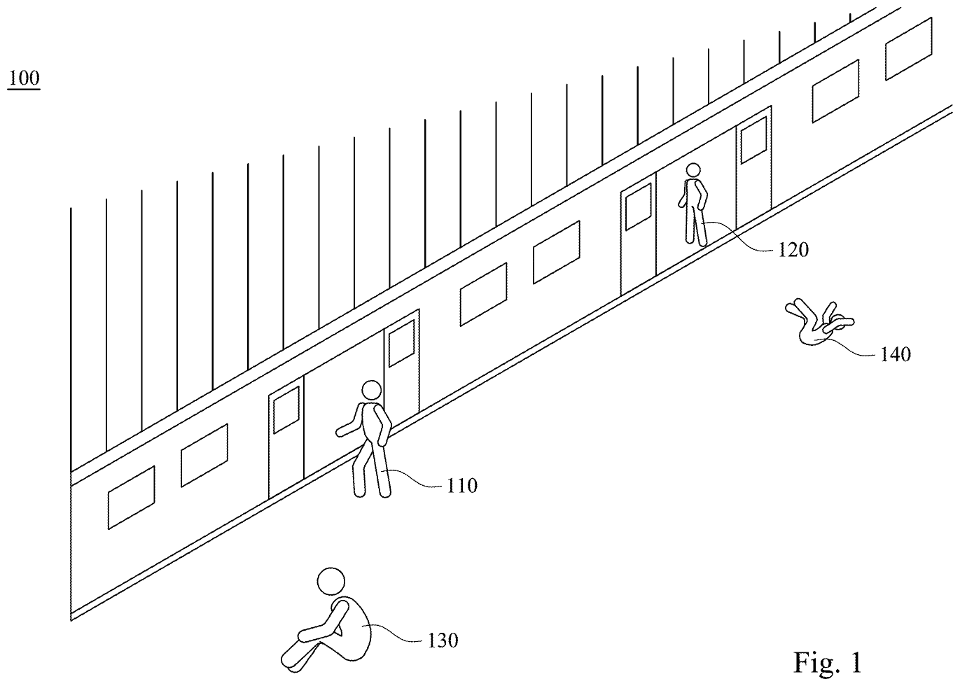

Reference is made to FIG. 1. FIG. 1 is a schematic diagram illustrating one of the pending recognition image 100 of a video captured in a scene according to some embodiments of the present disclosure. The pending recognition image 100 is the scene of the MRT platform. For determining whether any abnormal situation occurs by recognizing the video, the user (or the administrator) has a frame of image in the video (or called a picture), and the image is used as the pending recognition image 100, such that the pending recognition image 100 can be determined whether any people in the image is in the abnormal state. In some embodiments, the pending recognition image 100 includes a human body image, for example, the human body image 110, 120, 130, and 140. The method for acquiring the human body image will be described below. Many passengers in the MRT platform (shown as the human body image 110 and 120) are going into the carriage. Some passenger in the MRT platform (show as the human body image 130) is sitting on the floor. Some passenger in the MRT platform (shown as the human body image 140) is lying down on the floor.

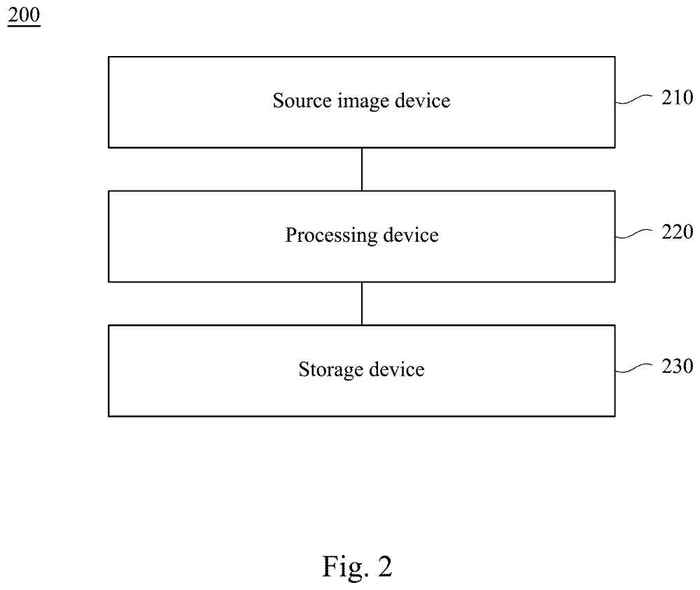

Reference is made to FIG. 2. FIG. 2 is a block diagram of a recognition system 200 of human body posture according to some embodiments of the present disclosure. The recognition system 200 of human body posture can automatically detect a human body posture of the image by recognizing a human body skeleton of the image.

As shown in FIG. 2, the recognition system 200 of human body posture includes a source image device 210, a processing device 220, and a storage device 230. The source image device 210 and the storage device 230 are coupled with the processing device 220.

In some embodiments, the source image device 210 (such as a camera) receives a plurality of pending recognition images. The pending recognition image is an image captured from a live stream or video. For example, when the frame per second (fps) of the video is 30 fps, it represents that the video shows 30 frames per second. The pending recognition image is any static picture of the video. In another embodiment, the source image device 210 also receives a live stream or the pending recognition image which is captured from a stored video.

In some embodiments, the storage device 230 stores a posture recognition model. After the posture recognition model inputs a skeleton image, a recognition result is outputted. For example, the posture recognition model stores a plurality of skeleton images and corresponding human body postures. When the pending recognition image is inputted into the posture recognition model and a determination is made that the pending recognition image includes the skeleton image, the skeleton image can be applied for recognizing the human body posture and the recognition result is outputted. The posture recognition model can be, but is not limited to, the convolutional neural network (CNN) model. The CNN can be LeNet, AlexNet, VGGNet, GoogLeNet (Inception), ResNet, and so on, and the CNN module of the disclosure is not limited herein.

In some embodiments, the skeleton image that the processing device 220 needs for generating the posture recognition model from the pending recognition images includes one or more skeleton. The method for acquiring the skeleton image from the images is, for example, the human body keypoint detection algorithm. The human body keypoint detection algorithm is performed to detect the human body keypoint, such as the joints, to sketch the skeleton or each body part information of the human body. The human body keypoint detection algorithm can be, but is not limited to, the OpenPosealgorithm, the regional multi-person pose estimation algorithm (RMPE), the DeepCut algorithm, the Mask R-CNN algorithm, and so on. It should be noted that any algorithm performed to detect the human body parts can be also applied in the present disclosure. After performing the human body keypoint detection algorithm to obtain the joint locations of the human body, the skeleton image can be sketched by the link between the coordinates of the joint locations.

It should be noted that the pending recognition images are the images or pictures captured from the live stream or videos, and the pending recognition image may not include the human body or may include one or more than one human body. When the processing device 220 generates the skeleton image from one pending recognition image, and if the pending recognition image does not include the skeleton image, the pending recognition image will not be inputted into the posture recognition model. One or more skeleton images can be captured from the pending recognition image, and each skeleton image of the pending recognition image will be inputted one-by-one into the posture recognition model for recognition.

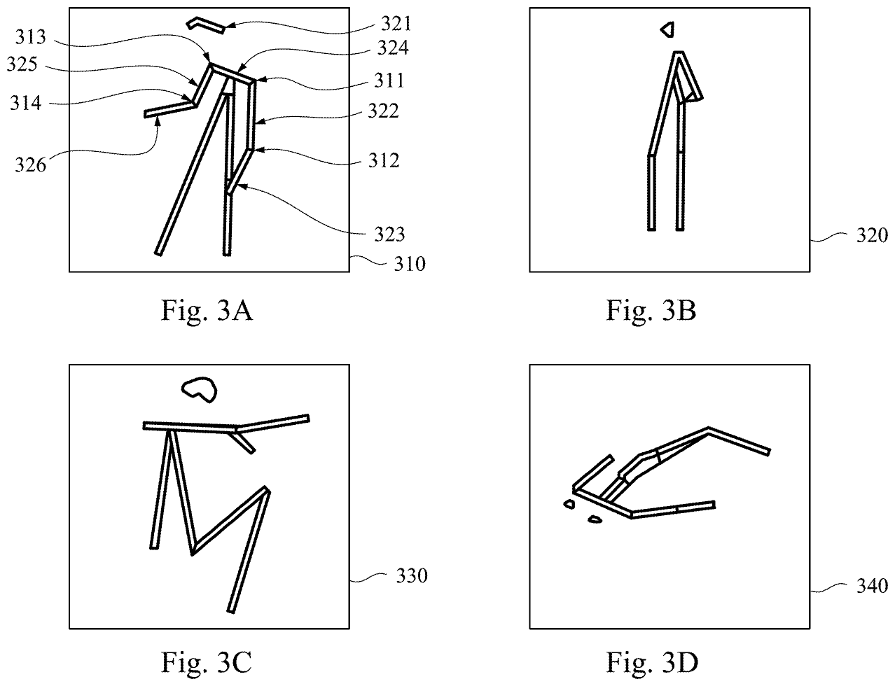

For further descriptions of the skeleton image in the present disclosure, reference is made to FIG. 1 and FIG. 3A to FIG. 3D. FIG. 3A to FIG. 3D show skeleton images 310 to 340 stored in a posture recognition model according to some embodiments of the present disclosure. In some embodiments, the skeleton image 310 of FIG. 3A and the skeleton image 320 of FIG. 3B correspond to the standing human body posture. The skeleton image 330 of FIG. 3C corresponds to the squatting human body posture. The skeleton image 340 of FIG. 3D corresponds to the falling-down human body posture. It should be noted that the skeleton images 310 to 340 of FIG. 3A to FIG. 3D are shown as embodiments. There are multiple skeleton images that one skeleton image corresponds to one human body posture in the posture recognition mode. The more the skeleton images can improve the accuracy of the human body posture determinations.

In some embodiments, the skeleton of each skeleton image includes a plurality of joints and a plurality of limbs. Each limb has a corresponding limb color, and each limb color is different. For example, after the coordinates of the joints are computed, the lines between the joint coordinates (i.e., limbs) can be obtained to sketch the skeleton image.

In some embodiments, the skeleton image 310 of FIG. 3A includes the joints 311, 312, 313, and 314. The limb 322 between the joints 311 and 312 is the left upper arm. The limb 325 between the joints 313 and 314 is the right upper arm. The limb 324 between the joints 311 and 313 is the shoulder. The limb 321 which is on the top of the limb 324 is the head. The limb 323 from the joint 312 to the acral joint is the left underarm. The limb 326 from the joint 314 to the acral joint is the right underarm. FIG. 3A shows part o limbs for an embodiment, the limbs are not limited herein.

In some embodiments, the limbs 321, 322, 323, 324, 325, and 326 include the corresponding limb color, and each limb color is different. For example, the color of the limb 321 is red, the color of the limb 322 is light green, the color of the limb 323 is dark green, the color of the limb 324 is purple, and the color of the limb 325 is yellow, and the color of the limb 326 is aquamarine. Because each of the limb colors is different, the left side and the right side of the human body can be recognized by the skeleton. When the limbs of the skeleton partially overlapped, the limb colors assist the recognization of the human body posture, such that the determination can be made easier and more accurately. Furthermore, because the distance between the human body and the camera (source image device) is different case by case, the resolution of the skeleton image may be different, such as blur or clear. To use the skeleton with the corresponding distance with the camera, the larger the ratio of the pixel amount of the human body image of the skeleton image to the pixel amount of the pending recognition image is, the thinner the limbs of the skeleton are. On the contrary, the smaller the ratio is, the wider the lines of limbs of the skeleton are.

In some embodiments, the processing device 220 acquires the human body image from the pending recognition images and applies the human body keypoint detection algorithm to acquire a plurality of key point coordinates of the human body image. Then, the processing device 220 obtains the skeleton image and its limbs of the human body according to the link between the key point coordinates. In some embodiments, the key point coordinates correspond to the joints of the skeleton image.

Reference is further made to FIG. 1 and FIG. 2. The processing device 220 is configured to generate the skeleton image from the pending recognition image 100. For example, the processing device 220 executes the human body keypoint detection algorithm on the pending recognition image 100 in FIG. 1. Because there are four passengers in the pending recognition image 100, the processing device 220 generates four skeleton images (not shown in FIG. 1) that correspond to the human body images 110 to 140 respectively.

In some embodiments, the processing device 220 inputs the four skeleton images into the posture recognition model to output the recognition result. For example, the processing device 220 obtains a first skeleton image (not shown in FIG. 1) by computing on the human body image 110 and inputs the first skeleton image into the posture recognition model. The posture recognition model pre-stores the skeleton images (e.g., the skeleton images 310 to 340 in FIG. 3A to FIG. 3D) and compares the skeleton images with the first skeleton image to determine whether any skeleton image is the same or similar to the first skeleton image. In one embodiment, the skeleton image 310, as shown in FIG. 3A, is found in the posture recognition model which is the same or similar to the first skeleton image. Because the skeleton image 310 corresponds to the standing human body posture, the processing device 220 outputs the recognition result which is the standing posture.

Similarly, the processing device 220 obtains a second skeleton image (not shown in FIG. 1) by computing on the human body image 120 and inputs the second skeleton image into the posture recognition model. In one embodiment, the skeleton image 320, as shown in FIG. 3B, is found in the posture recognition model which is the same or similar to the second skeleton image. Because the skeleton image 320 corresponds to the standing human body posture, the processing device 220 outputs the recognition result which is the standing posture.

Similarly, the processing device 220 obtains a third skeleton image (not shown in FIG. 1) by computing on the human body image 130 and outputs the third skeleton image into the posture recognition model. In the embodiment, the skeleton image 330, as shown in FIG. 3C, is found in the posture recognition model which is the same or similar to the third skeleton image. Because the skeleton image 330 corresponds to the squatting human body posture, the processing device 220 outputs the recognition result which is the squatting posture.

Similarly, the processing device 220 obtains a fourth skeleton image (not shown in FIG. 1) by computing on the human body image 140 and outputs the fourth skeleton image into the posture recognition model. In the embodiment, the skeleton image 340, as shown in skeleton image 340, is found in the posture recognition model which is the same or similar to the fourth skeleton image. Because the skeleton image 340 corresponds to the falling-down human body posture, the processing device 220 outputs the recognition result which is the falling-down posture.

In some embodiments, the processing device 220 determines whether abnormal information should be sent according to the recognition result. As described above, the processing device 220 determines that the falling-down posture of the human body of the passenger is recognized in the pending recognition image 100 in FIG. 1, and the abnormal state is confirmed. Then, the abnormal information is sent. It should be noted that the normal state or the abnormal state of the human body posture varies with the different scenes. For example, if a passenger falls down in the platform, it is dangerous (e.g, the person may fall down the track) or the disorder is induced (e.g., the passage is blocked). In these situations, the falling-down posture can be set as an abnormal posture.

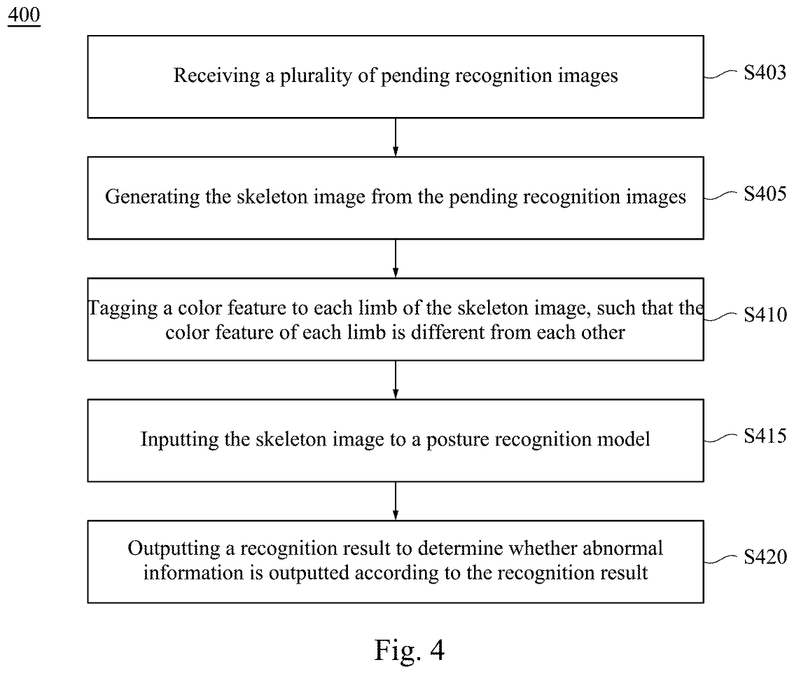

For further describing the recognition method of human body posture in the disclosure, reference is made to FIG. 2 and FIG. 4.

FIG. 4 is a flow chart illustrating a recognition method 400 of human body posture according to some embodiments of the present disclosure. The recognition method 400 of human body posture is performed by the recognition system 200 of human body posture in FIG. 2.

In step S403, receiving a plurality of pending recognition images is performed. In some embodiments, the recognition system 200 of human body posture receives a plurality of pending recognition images to recognize the pending recognition images.

In step S405, generating the skeleton image from the pending recognition images is performed. In some embodiments, the recognition system 200 of human body posture executes the human body keypoint detection algorithm on the pending recognition images to compute the skeleton image corresponding to each human body of the pending recognition images.

In some embodiments, the recognition method 400 of human body posture acquires the human body image from the pending recognition image and to obtain corresponding key point coordinate from the human body image. Then, the skeleton image and its limbs corresponding to the human body can be obtained according to the links between the key point coordinates. The key point coordinates correspond to the joints of the skeleton image.

In step S410, tagging a color feature to each limb of the skeleton image is performed, such that the color feature of each limb is different from each other. In some embodiments, each limb of the skeleton image that is pre-stored in the posture recognition model corresponds to a limb color. For example, the part of the head is tagged to the red color. When the limb of the skeleton image which is generated from the pending recognition image is tagged to the color feature, the same rule of tagging color features is applied, i.e., when the part of the head is recognized, the limb part will be tagged to the red color.

In step S415, inputting each skeleton image that is obtained from the pending recognition images to a posture recognition model is performed. In some embodiments, if multiple skeleton images are computed from the pending recognition image, each skeleton image will be inputted into the posture recognition model for determining each human body posture.

In some embodiments, the recognition method of human body posture 400 further adjusts a line width of each limb in the skeleton image. For example, the line width of the skeleton image is adjusted according to the ratio of the pixel amount of the human body image corresponding to the skeleton image to the pixel amount of the pending recognition images. For example, the ratio of the pixel amount of the human body image that includes the skeleton image to the pixel amount of the pending recognition images is computed. In some embodiments, the larger the ratio of the pixel amount of the human body image corresponding to the skeleton image to the pixel amount of the pending recognition images is (e.g., 18%), which represent that the human body is close to the camera, the thinner the line width in the skeleton image is. On the contrary, the smaller the ratio of the pixel amount of the human body image corresponding to the skeleton image to the pixel amount of the pending recognition images is (e.g., 3%), which represents that the human body is farther from the camera, the wider the line width in the skeleton image is. In some embodiments, because the distances between the human body and the camera are different, the blur/clear condition of the skeleton image varies correspondingly. If the skeletons with the different distances are applied to comparison, the accuracy will be enhanced. The human body that is farther from the camera contains a smaller pixel amount ratio and the line width of the skeleton is blur, so the line width of the skeleton is increased correspondingly. On the other hand, the human body that is close to the camera contains a larger pixel amount ratio and the line width of the skeleton is clear, so the line width of the skeleton is adjusted to be thin lines, such that the structure of the skeleton can be presented and the accuracy for recognizing the human body posture can be increased.

In step S420, outputting a recognition result to determine whether abnormal information is outputted according to the recognition result is performed. In some embodiments, if the recognition result satisfies the abnormal state, such as the falling-down posture, the determination that the abnormal state occurs in the scene is made. At this time, the recognition method of human body posture 400 will send the abnormal information for administrators to review.

The training method for the posture recognition model is described below.

In some embodiments, the posture recognition model is trained by using the plurality of training images. Reference is further made to FIG. 2. The processing device 220 receives a plurality of training images of the source image device 210. It should be noted that any frame of the multimedia stream and any scene which is captured as the static image can be used to be the training image.

In some embodiments, the processing device 220 executes the human body keypoint detection algorithm on the training images to obtain a plurality of trained skeleton images, such that each limb of every trained skeleton image includes the corresponding limb color.

In some embodiments, the processing device 220 tags the recognition result that the skeleton images correspond. For example, an operating interface is provided for the administrator to select the trained skeleton image and to record the corresponding human body posture. The operating interface also shows the original training image for the administrator to confirm and to record the corresponding human body posture. The skeleton images that include the limb colors and are tagged with the corresponding recognition results are inputted into the training model. For example, the deep learning algorithm is applied to train the model. The processing device 220 trains by the trained skeleton images which have the corresponding limb colors and the corresponding recognition result to generate the posture recognition model.

In some embodiments, the processing device 220 computes a spatial feature by the pixel amount of the human body image of the trained skeleton image in each training image. The processing device 220 obtains the trained skeleton according to the plurality of key point coordinates of each training image and the spatial feature of the human body image. For example, one or more human body is included in the training image, and the human body image corresponding to the human body can be further obtained from the training image. In some embodiments, the depth of field data of the human body image includes or corresponds to the distance between the human body and the camera. In some embodiments, the distance between the human body image and the camera can be estimated from the ratio of the pixel amount of the human body image to the pixel amount of the training image to obtain the spatial feature. The spatial feature can be the depth of field data of the human body image. In some embodiments, the processing device 220 adjusts the line width of the skeleton in the skeleton image of the human body image according to the depth of field data.

In some embodiments, if the depth of field data of the human body image indicates that the distance between the human body and the camera is far, the line width of the skeleton in the skeleton image of the human body image is widened. In other embodiment, if the depth of field data of the human body image indicates that the distance between the human body and the camera is close, the line width of the skeleton in the skeleton image of the human body image is narrowed.

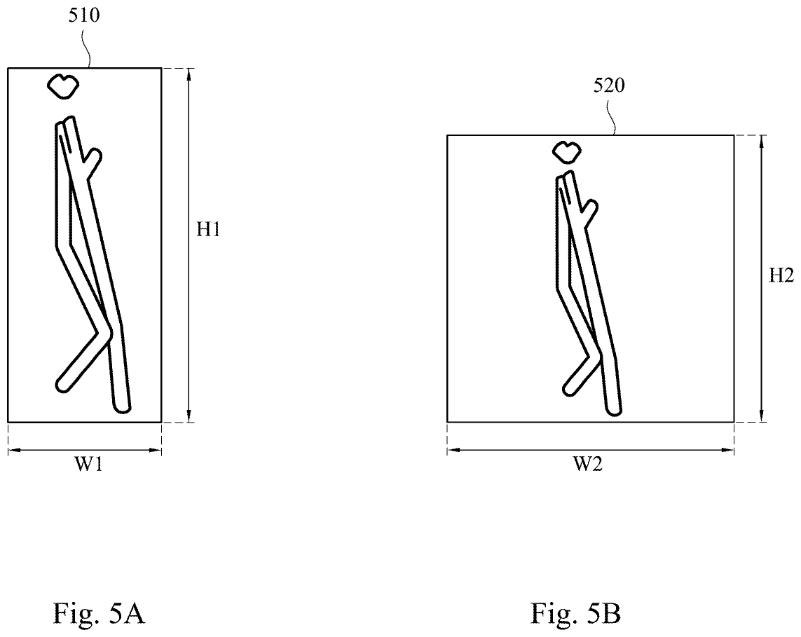

In some embodiments, the recognition method of human body posture 400 adjusts the size of the skeleton image with an equal proportion, such that the size-adjusted skeleton images are applied to train the posture recognition model. FIG. 5A to FIG. 5B shows a schematic diagram of adjusting the skeleton images 510 and 520 according to some embodiments of the present disclosure. As shown in FIG. 5A, the skeleton image 510 is obtained from the training image. The method for obtaining the skeleton images is shown above and not repeated herein. The image width of the skeleton image 510 is W1 (e.g., 100 pixels) and the image height is H1 (e.g., 200 pixels). For the consistency of the size of the skeleton image which is inputted into the posture recognition model, the size of the skeleton image 510 will be normalized. For example, the size of all the skeleton images is adjusted as the same, e.g., scaling down the image to be 48 pixels of the image width and 48 pixels of the image height. In one embodiment, the skeleton image 510 is scaled down (e.g., 100 pixels×200 pixels is scaled down to be 24 pixels×48 pixels), and the image width of 24 pixels which is smaller than 48 pixels is broadened by filling vacancy pixels to be 48 pixels. As shown in FIG. 5B, the image size of the skeleton image 520 which is adjusted has the image width W2 (e.g., 48 pixels) and the image height H2 (e.g., 48 pixels). All the skeleton images have the same aspect ratio and the same image size. By the image normalization, the accuracy of the determination of the human body posture can be confirmed, also the accuracy of training and recognizing the images by the deep learning algorithm can be increased.

In some embodiments provide a non-transitory computer-readable storage medium storing multiple instructions. When the instructions are loaded into the processor or the processing device 220 in FIG. 2, the processing device 220 executes the instructions to perform steps of FIG. 4. For example, the processing device 220 receives a plurality of pending recognition images, generates a plurality of skeleton images from the pending recognition images, inputs the skeleton images into the posture recognition model to output the corresponding recognition result. And, the processing device 220 determines whether the abnormal information is sent according to the corresponding recognition result.

As described above, the recognition system of human body posture and the recognition method of human body posture in the present disclosure applies the skeleton images which are acquired from the human body images to perform posture comparisons. Because each limb of the skeleton image has a different color feature, when the overlap of the limbs or the human bodies occur, the convention method for recognizing images by the gray level cannot improve the efficiency. On the contrary, the method that each limb has a different color feature in the disclosure can improve the accuracy of the processing device performing visual recognizations. In addition, because the human body image is small when the human body is at a far position, it will decrease the accuracy of the processing device performing visual recognizations. Hence, in the present disclosure, the line width of the skeleton of the human body that is at a far position is widened according to the depth information of the human body image, such that the connection relationship between the limbs can be recognized more easily. Furthermore, the skeleton image size is smaller than the training image size and the pending recognition image size, the computation time of training images and recognizing postures can be reduced and increases the training and recognizing efficiency. Accordingly, the system and the method provided in the present disclosure which applies the color feature of the limbs and the space information has high processing efficiency and accuracy in training images and recognizing postures.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A recognition system of human body posture, comprising:
a source image device configured to receive a plurality of pending recognition images;
a storage device configured to store a posture recognition model, wherein the posture recognition model is configured to input a skeleton image and output a recognition result, the skeleton image comprises a skeleton and the skeleton comprises a plurality of joints and a plurality of limbs, each of the limbs corresponds to a limb color, and each of the limb colors is different from each other; and
a processing device coupled with the source image device and the storage device, wherein the processing device is configured to:
generate the skeleton images from the pending recognition images;
input the skeleton images into the posture recognition model respectively to output the recognition result which corresponds to the skeleton images inputted; and
determine whether abnormal information is sent according to the recognition result.

2. The recognition system of human body posture of claim 1, wherein the posture recognition model is generated by training a plurality of training images, and the posture recognition model is trained by the processing device that uses the training images to obtain a plurality of trained skeleton images, such that each of the limbs in each of the trained skeleton images has the limb color, and each of the trained skeleton images is tagged on the recognition result, and the posture recognition model is trained and generated according to the trained skeleton images which comprise the limb colors and the recognition results.

3. The recognition system of human body posture of claim 2, wherein a spatial feature is computed by the processing device that uses a pixel amount of a human body image which corresponds to the trained skeleton image of the training images to obtain the trained skeleton images according to a plurality of key point coordinates of each training image and the spatial feature of the human body image.

4. The recognition system of human body posture of claim 3, wherein a line width of each limb of a specific skeleton is determined by a ratio of the pixel amount of the human body image in which the skeleton image corresponds to the pixel amount of the pending recognition images.

5. The recognition system of human body posture of claim 1, wherein when a ratio of the pixel amount of the human body image which the skeleton image corresponds to the pixel amount of the pending recognition images is large, the line width of each limb of the skeleton is thin, and when the ratio is small, the line width of each limb of the skeleton is wide.

6. The recognition system of human body posture of claim 3, wherein the spatial feature comprises a depth of field data of the human body image which the skeleton image corresponds to adjust the line width of each limb of the skeleton image in the human body image by the depth of field data.

7. The recognition system of human body posture of claim 6, wherein the when the depth of field data of the human body image indicates that a distance from the human body to the source image device is far, the line width of a skeleton of the skeleton image in the human body image is wide, and when the depth of field data of the human body image indicates that the distance from the human body to the source image device is nearby, the line width of a skeleton of the skeleton image in the human body image is thin.

8. The recognition system of human body posture of claim 1, wherein the processing device is further configured to acquire at least one of the human body images from the pending recognition images, to obtain a plurality of key point coordinates from each of the human body images, and to obtain the skeleton images and the limbs of each human body by connecting lines among a plurality of key point coordinates.

9. The recognition system of human body posture of claim 8, wherein each of the key point coordinates corresponds to one of the joints in the skeleton image.

10. The recognition system of human body posture of claim 2, wherein the processing device is further configured to adjust sizes of the skeleton images by an equal proportion to train the posture recognition model by the skeleton images which sizes are adjusted.

11. A recognition method of human body posture, comprising:
receiving a plurality of pending recognition images;
generating a plurality of skeleton images from the pending recognition images, wherein the skeleton image comprises a skeleton, the skeleton comprises a plurality of joints and a plurality of limbs, each of the limbs corresponds to a limb color, and each of the limb colors is different from each other;
inputting the skeleton images into a posture recognition model respectively to output a recognition result which corresponds to the skeleton images inputted; and
determining whether abnormal information is sent according to the recognition result.

12. The recognition method of human body posture of claim 11, further comprising:
generating the posture recognition model by training with a plurality of training images;
obtaining a plurality of trained skeleton images by using the training images, such that each of the limbs in each of the trained skeleton images has the limb color;
tagging the recognition result on each of the trained skeleton images; and
training and generating the posture recognition model according to the trained skeleton images which comprise the limb colors and the recognition results.

13. The recognition method of human body posture of claim 12, further comprising:
computing a spatial feature by using a pixel amount of a human body image which corresponds to the trained skeleton image of the training images; and
obtaining the trained skeleton images according to a plurality of key point coordinates of each training image and the spatial feature of the human body image.

14. The recognition method of human body posture of claim 13, further comprising:
determining a line width of each limb of a specific skeleton according to a ratio of the pixel amount of the human body image in which the skeleton image corresponds to the pixel amount of the pending recognition images.

15. The recognition method of human body posture of claim 11, wherein when a ratio of the pixel amount of the human body image which the skeleton image corresponds to the pixel amount of the pending recognition images is large, the line width of each limb of the skeleton is thin, and when the ratio is small, the line width of each limb of the skeleton is wide.

16. The recognition method of human body posture of claim 13, wherein the spatial feature comprises a depth of field data of the human body image which the skeleton image corresponds, and the recognition method of human body posture further comprises adjusting the line width of each limb of the skeleton image in the human body image by the depth of field data.

17. The recognition method of human body posture of claim 11, further comprising:
acquiring at least one of the human body images from a plurality of pending recognition images;
obtaining a plurality of key point coordinates from each of the human body images; and
obtaining the skeleton images and the limbs of each human body by connecting lines among a plurality of key point coordinates.

18. The recognition method of human body posture of claim 17, wherein each of the key point coordinates corresponds to one of the joints in the skeleton image.

19. The recognition method of human body posture of claim 12, further comprising:
adjusting sizes of the skeleton images by an equal proportion to train the posture recognition model by the skeleton images which sizes are adjusted

20. A non-transitory computer-readable storage medium, comprising instructions stored thereon, the instructions being configured to cause a processor to:
receive a plurality of pending recognition images;
generate a plurality of skeleton images from the pending recognition images, wherein the skeleton image comprises a skeleton, the skeleton comprises a plurality of joints and a plurality of limbs, each of the limbs corresponds to a limb color, and each of the limb colors is different from each other;
input the skeleton images into a posture recognition model respectively to output a recognition result which corresponds to the skeleton images inputted; and
determine whether abnormal information should be sent according to the recognition result.
